(19) United States
(12) Patent Application Publication
(10) Pub. No.: US 2025/0262580 A1
(43) Pub. Date: Aug. 21, 2025

(54) POOL PUMP INLET FILTER ASSEMBLY

(71) Applicant: SPLASH POOL & SPA, INC., Ningbo (CN)

(72) Inventors: Huaiping WANG, Ningbo City (CN); Paul LAMBOURN, Johannesburg, Gauteng (ZA); Michael Richard TREGONING, Evendale (ZA)

(21) Appl. No.: 19/055,840

(22) Filed: Feb. 18, 2025

Related U.S. Application Data
(60) Provisional application No. 63/555,580, filed on Feb. 20, 2024.

(51) Int. Cl. B01D 35/31; E04H 4/12

(52) U.S. Cl. CPC B01D 35/31; E04H 4/1209; B01D 2201/305

(57) ABSTRACT

A pool pump inlet filter assembly includes a filter housing, and a handle having central portion for grasping and a pair of opposing legs secured to the filter housing, where each leg of the pair of opposing legs has a lifting cam and a spaced apart locking pin. The filter assembly also includes a cover removable secured to the filter housing, and a cam cleat secured to an edge of the cover where the cam cleat has a lower surface and an upper surface. The lower surface of the cam cleat is configured to engage the lifting cam and the upper surface is configured to engage the locking pin to secure the cover to the filter housing. The cam cleat comprises a detent configured to receive the locking pin when clamping the cover to the filter housing.

### RELATED APPLICATIONS

This application claims priority to U.S. Provisional Application Ser. No. 63/555,580 filed on Feb. 20, 2024, the contents of which are herein incorporated by reference in their entirety.

### FIELD

The present invention relates to the field of pool pumps, and more particularly, to pool pump inlet filter assemblies.

### BACKGROUND

Typical swimming pool pumps feature a filter assembly arranged in-line with the pump inlet to remove larger debris that might damage the pump impeller were it ingested into the pump. Such filter assemblies usually feature a filter body defining a filter chamber connected between the pool suction line and the pump inlet. A removable filter basket is arranged in the filter chamber to collect the debris. Removal of the filter basket is achieved by removing a cover from the top of the filter body, after which the basket can simply be pulled out, emptied and returned to the filter chamber. The cover is typically threaded over of the top of the filter body, so as to screw on and off.

While the filter assembly design is quite simple, removal of the cover can still be difficult for the end user. To avoid air ingestion during pump operation, there must be a good seal between the cover and the filter body. As a result, operation of the pump draws a vacuum on the filter chamber, increasing the force required to subsequently break the seal between the filter body and the filter cover. Often ears or other protrusions are provided on the cover, but the user must still apply a significant amount of torque to remove the cover manually. Hitting fingers or hands on adjacent piping once the cover gives way is not an uncommon occurrence, nor is having recourse to a mallet or the like to assist cover removal while risking damage to adjacent piping joints and other components.

Accordingly, there is a need in the art for an inlet filter assembly with improved access to the filter chamber and filter basket while not affecting the efficiency of the filter assembly.

### SUMMARY

A pool pump inlet filter assembly is disclosed. The assembly includes a filter housing, and a handle that includes a central portion for grasping and a pair of opposing legs secured to the filter housing. Each leg of the pair of opposing legs has a lifting cam and a spaced apart locking pin. The filter assembly also includes a cover removable secured to the filter housing, and a cam cleat secured to an edge of the cover where the cam cleat has a lower surface and an upper surface. The lower surface of the cam cleat is configured to engage the lifting cam, and the upper surface is configured to engage the locking pin to secure the cover to the filter housing. The cam cleat includes a detent configured to receive the locking pin when clamping the cover to the filter housing. The locking pin on each leg extends inward.

The cam cleat may comprise a first cam cleat secured to an edge of the cover and a second cam cleat secured to the edge of the cover opposite the first cam cleat. The cam cleat may also have a wedge shape.

The lifting cam may have a lobe that is configured to exert an upward force on the cam cleat as the handle is rotated, and a hinge may be coupled to the edge of the cover about which the cover rotates between a closed position and an open position on the filter housing. The handle may be U-shaped and the cover may have a circular shape that is configured to fit over a filter basket of the filter housing. The lifting cam may have a triangular shape.

The upper surface of the cam cleat may be curved relative to the lower surface, and the cam cleat is configured to be clamped between the locking pin and the lifting cam of at least one of the legs of the handle. The handle is upright when in a locked position.

In another aspect, a method of operating a cover on a pool pump inlet filter assembly described above is disclosed. The method includes moving the handle forward over the cover until the lifting cam engages the lower surface of the cam cleat and breaks a seal between the filter housing and the cover in order for the cover to be opened. In addition, the method includes moving the handle rearward back over the cover until the locking pin on each leg of the pair of opposing legs engages with a respective detent of the cam cleat to clamp the cover in place on the filter housing.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a pool pump inlet filter assembly in a closed state and in which various aspects of the disclosure may be implemented;

FIG. 2 is an end view of the filter assembly of FIG. 1;

FIG. 3 is a partial cross-sectional view taken along line 3-3 of FIG. 2;

FIG. 4 is a perspective view of the filter assembly of FIG. 1 with a handle of the assembly moved forward;

FIG. 5 is an end view of the filter assembly of FIG. 4;

FIG. 6 is a sectional view taken along line 6-6 of FIG. 5; and

FIG. 7 is a perspective view of the filter assembly of FIG. 1 in an open state.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

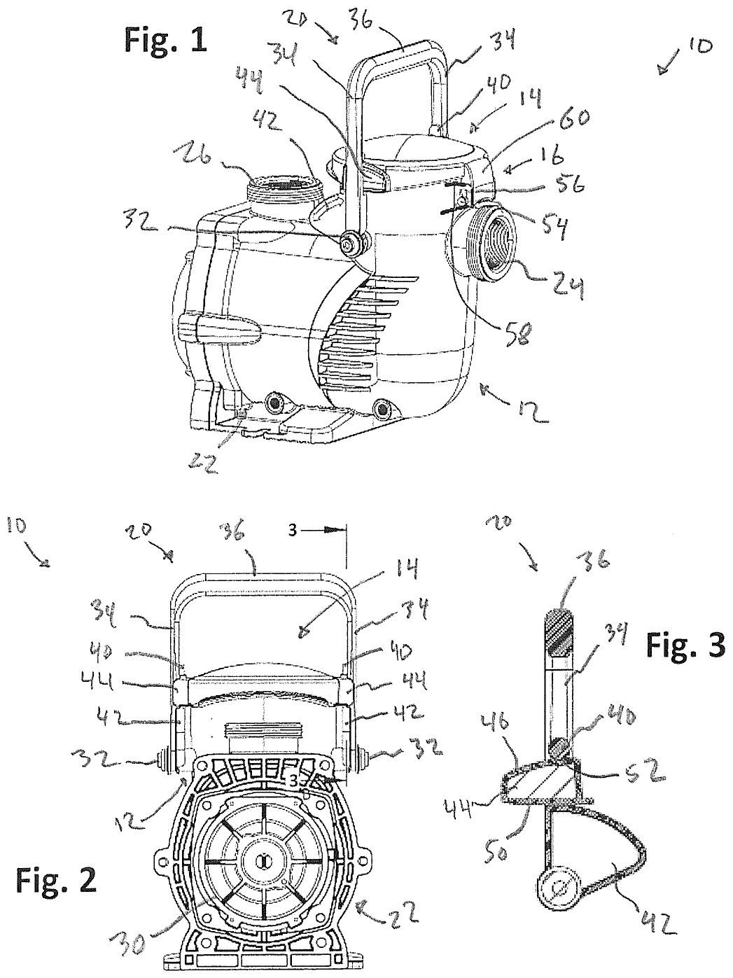

Referring now to FIG. 1, a pool pump inlet assembly of the present invention is depicted and generally designated 10. In a particular aspect, the assembly includes a filter housing 12 that can be selectively closed by a cover 14. The cover is attached to the filter housing 12 by a hinge 16. A handle 20 includes opposing legs 34, which are secured to opposite sides of the filter housing 12. The handle 20 is operable to secure the cover 14 in the closed state (as in FIG. 1) and facilitate opening the cover 14 to allow access to an interior of the filter housing 12.

The filter housing 12 is typically formed integrally with an impeller housing 22 of a pool pump. Accordingly, a pump inlet 24 is formed on the housing 12 and a pump outlet 26 is formed on the impeller chamber 22. In operation, water is drawn in through the inlet 24 and must pass through the interior of the filter housing 12 and a filter basket located therein before entering the impeller housing 22 and being pumped to the outlet 26. A pump motor (not shown) will usually be connected to a rear face 30 of the impeller housing 22. A cylindrical filter housing, as in the depicted embodiment, is the most common configuration, although it will be appreciated by those of ordinary skill in the art, that the present invention could be realized in connection with any filter assembly having a removable cover.

The handle 20 is coupled to opposite sides of the filter housing 12 by respective pivot joints 32 as shown in FIG. 2. The legs 34 of the handle 20 extend above the cover 14 and are connected by a central portion 36. The central portion 36 is configured to be grasped by a hand of a user. A locking pin 40 extends inwardly from each leg 34 of the handle 20 to engage the cover 14 in the closed position. This ensures a tight seal with the filter housing 12. A lifting cam 42 extends inwardly from each leg 34 below the respective locking pin 40 to facilitate breaking the seal between the cover 14 and the housing 12, as will be explained in more detail below.

Referring now to FIG. 3, a cam cleat 44 extends from each side of the cover 14 with an upper surface 46 of each cam cleat configured to be engaged by the respective locking pin 40 and a lower surface 50 configured to be engaged by the respective lifting cam 42. A detent 52 is formed in the cam cleat 44 proximate a rear edge of each upper surface 46. The detent 52 is configured for receiving the respective locking pin 40 when the handle 20 is in the closed position (i.e. upright). The upper surface 46 of the cam cleat may slope downwardly forward of the detent 52.

The hinge 16 includes hinge pins 54 pivotally received in hinge openings 56 formed in hinge plates 58. The hinge pins 54 extend from opposite sides of a hinge arm 60 extending downwardly from a forward edge of the cover 14 and the hinge plates 58 extend outwardly from the filter housing 12 on opposite sides of the hinge arm 60. The hinge openings 56 are elongated vertically, allowing the hinge pins 54 to move vertically therewithin as well as rotating.

Generally, an elastic seal is provided between the cover 14 and the top of the filter body 12, which will be somewhat compressed in the closed state, urging the cover 14 upwardly against the locking pins 40, such that some degree of force is necessary to disengage the locking pins 40 from the detents 52.

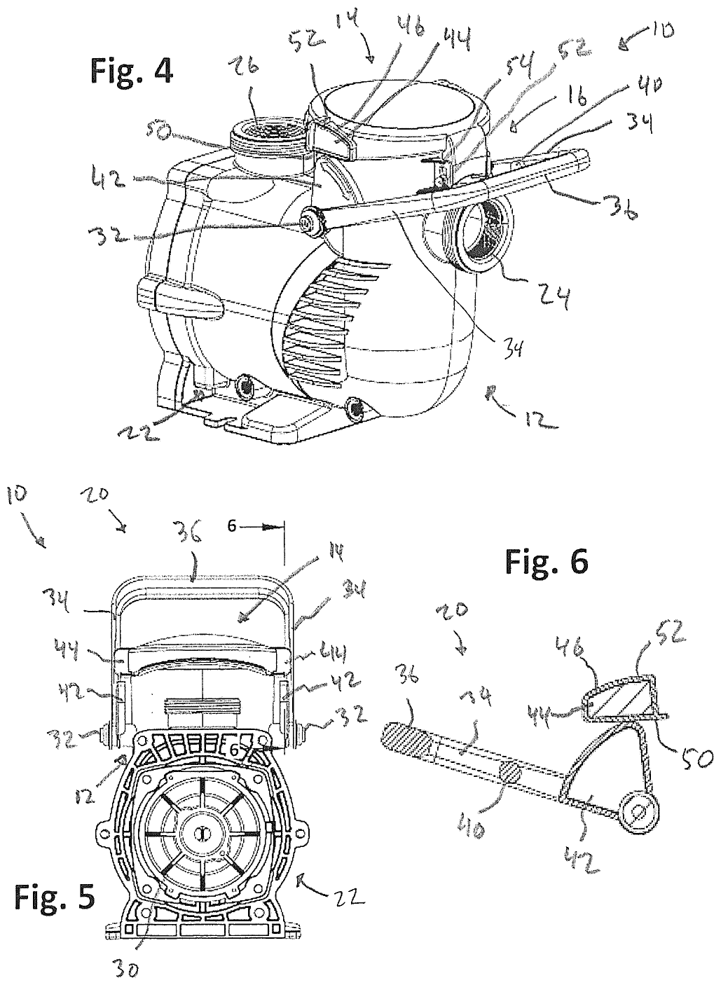

To open the cover 14, the user grasps the central portion 36 of the handle 20 and urges it forwardly with sufficient force to disengage the locking pins 40 from the detents 52, as depicted in FIGS. 4-6. As the handle 20 is moved forwardly, the lifting cams 42 engage the lower surfaces 50 of the cam cleats 44, urging the cover 14 upwards to break the seal with the filter housing 12. The downward slopes on the upper surfaces 46 of the cam cleats 44 allow increasing upward movement below the locking pins 40 until the locking pins 40 completely clear the upper surfaces 46 of the cam cleats 44. The vertically elongated hinge openings 56 allow play of the hinge pins 54 to accommodate non-rotational movement as the cover 14 is urged upwardly by the lifting cams 42.

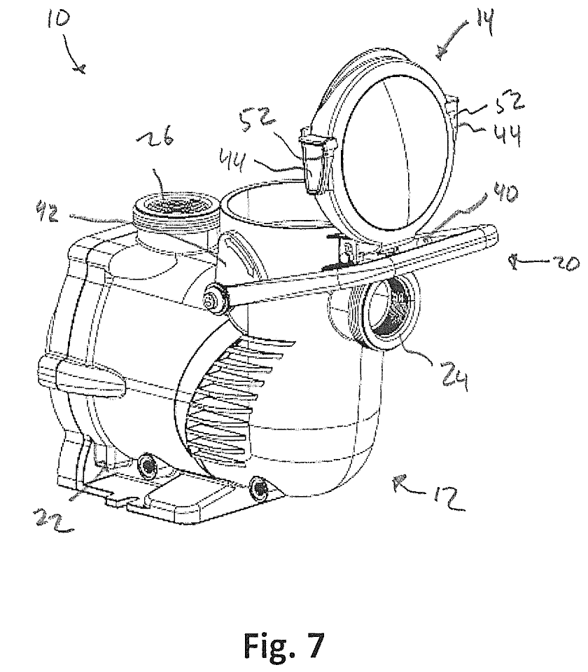

Referring now to FIG. 7, with the handle 20 moved completely clear of the cover 14, the cover 14 can pivot fully open, allowing the internal filter basket to be removed, cleaned and reinstalled. Returning the assembly 10 to the closed state is accomplished by pivoting the cover 14 back over the filter housing 12 and returning the handle 20 to its upright position with the locking pins 40 engaged in the respective detents 52.

The mechanical advantage afforded by the handle 20 significantly reduces the exertion required by the user to break a vacuum seal between the cover 14 and the filter housing 12. Additionally, it is simple to determine when the cover 14 is fully closed by the location of the handle 20 being upright, and prospective under- or over-tightening of the cover is avoided.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A pool pump inlet filter assembly comprising:
a filter housing;
a handle having a pair of opposing legs secured to the filter housing, each leg of the pair of opposing legs having a lifting cam and a spaced apart locking pin;
a cover removable secured to the filter housing; and
a cam cleat secured to an edge of the cover and having a lower surface and an upper surface;
wherein the lower surface of the cam cleat is configured to engage the lifting cam and the upper surface is configured to engage the locking pin to secure the cover to the filter housing.

2. The pool pump inlet filter assembly of claim 1, wherein the cam cleat comprises a first cam cleat secured to an edge of the cover and a second cam cleat secured to the edge of the cover opposite the first cam cleat.

3. The pool pump inlet filter assembly of claim 1, wherein the cam cleat comprises a detent configured to receive the locking pin and clamp the cover to the filter housing.

4. The pool pump inlet filter assembly of claim 1, wherein the cam cleat having a wedge shape.

5. The pool pump inlet filter assembly of claim 1, wherein the handle having a central portion spanning across the pair of opposing legs.

6. The pool pump inlet filter assembly of claim 1, wherein the lifting cam includes a lobe that is configured to exert an upward force on the cam cleat as the handle is rotated.

7. The pool pump inlet filter assembly of claim 1, further comprising a hinge coupled to the edge of the cover and the filter housing and about which the cover rotates between a closed position and an open position.

8. The pool pump inlet filter assembly of claim 1, wherein the handle is U-shaped.

9. The pool pump inlet filter assembly of claim 1, wherein the cover comprises a circular shape and configured to fit over a filter basket of the filter housing.

10. The pool pump inlet filter assembly of claim 1, wherein the lifting cam has a triangular shape.

11. The pool pump inlet filter assembly of claim 1, wherein the locking pin on each leg extends inward.

12. The pool pump inlet filter assembly of claim 1, wherein the upper surface of the cam cleat being curved relative to the lower surface.

13. The pool pump inlet filter assembly of claim 1, wherein the cam cleat is configured to be clamped between the locking pin and the lifting cam of at least one of the legs of the handle.

14. The pool pump inlet filter assembly of claim 1, wherein the handle is upright when in a locked position.

15. The pool pump inlet filter assembly of claim 1, further comprising an impeller housing coupled to the filter housing.

16. A pool pump inlet filter assembly comprising:
a filter housing;
a handle having a first leg and a second leg secured to the filter housing, each of the first and the second legs having a respective lifting cam and a respective spaced apart locking pin;
a cover removable secured to the filter housing; and
a first cam cleat secured to an edge of the cover and a second cam cleat secured to the edge of the cover opposite the first cam cleat, each of the first and the second cam cleats having a respective detent formed in an upper surface thereof;
wherein a lower surface of the first cam cleat and the second cam cleat are configured to engage the respective lifting cam, and the respective detent of the upper surfaces of the first cam cleat and the second cam cleat are configured to engage the respective locking pin to secure the cover to the filter housing.

17. The pool pump inlet filter assembly of claim 16, wherein the first cam cleat and the second cam cleat each have a wedge shape.

18. The pool pump inlet filter assembly of claim 17, wherein the respective lifting cam of the first leg and the second leg each include a lobe that is configured to exert an upward force on the respective cam cleat as the handle is rotated.

19. A method of operating a cover on a pool pump inlet filter assembly having a handle comprising a pair of opposing legs secured to a filter housing, wherein each leg of the pair of opposing legs has a lifting cam and a spaced apart locking pin, a cam cleat secured to an edge of the cover and having a lower surface and an upper surface, wherein the lower surface of the cam cleat is configured to engage the lifting cam and the upper surface is configured to engage the locking pin to secure the cover to the filter housing, the method comprising:
moving the handle forward over the cover until the lifting cam engages the lower surface of the cam cleat and breaks a seal between the filter housing and the cover in order for the cover to be opened.

20. The method of claim 19, further comprising moving the handle rearward back over the cover until the locking pin on each leg of the pair of opposing legs engages with a respective detent of the cam cleat to clamp the cover in place on the filter housing.
